(19) United States
(12) Patent Application Publication
(10) Pub. No.: US 2021/0065121 A1
(43) Pub. Date: Mar. 4, 2021

(54) DISTRIBUTED DATA COLLECTION SYSTEM

(71) Applicant: TRISK TECHNOLOGIES, INC., Burlingame, CA (US)

(72) Inventors: Thomas M. Brehmer, Burlingame, CA (US); Yuri Vizitei, Columbia, MO (US); Todd A. Suchevits, San Francisco, CA (US)

(21) Appl. No.: 16/963,596

(22) PCT Filed: Jan. 22, 2019
(86) PCT No.: PCT/US19/14592

§ 371 Date: Jul. 21, 2020

Related U.S. Application Data
(60) Provisional application No. 62/620,821, filed on Jan. 23, 2018.

(51) Int. Cl. G06Q 10/10; G06F 16/93; H04L 29/08

(52) U.S. Cl. CPC G06Q 10/103; H04L 67/14; G06Q 10/107; G06F 16/93

(57) ABSTRACT

Various embodiments described herein provide for a distributed data collection system. In particular, some embodiments associate a workflow with a workflow identifier, wherein the workflow comprises a set of interactive forms, cause display of a set of workflow identifiers that include the workflow identifier at a first client device, receive a selection of the workflow identifier from among the set of workflow identifier from the first client device, cause display of a first interactive form associated with the workflow at the first client device and at a second client device in response to receiving the selection, receive a response to the first interactive form from the second client device, identify a document from a document library based on the response to the first interactive form, and distribute the document to the second client device.

### RELATED APPLICATIONS

This international application claims the benefit of priority to U.S. Provisional Application No. 62/620,821, filed on Jan. 23, 2018, entitled “DISTRIBUTED DATA COLLECTION SYSTEM,” which is incorporated herein by reference in its entirety.

### TECHNICAL HELD

The present disclosure relates generally to data collection, and, more particularly, various embodiments described herein provide for systems, methods, techniques, instruction sequences, and devices for a distributed data collection system.

### BACKGROUND

Collection of information using computer-enabled technologies is essential for business operations, especially in contexts where a third-party advisor or consultant provides professional assistance or services to a client. For instance, the use of electronic questionnaires or forms can be beneficial in collecting client information with respect to tax preparation, rendering legal advice or services (e.g., filing corporate documents), providing technical support, handling insurance claims, or seeking medical services.

Information collection has become exceedingly difficult in the current business environment, as many advisor/consultants and clients resort to using e-mail correspondence or shared data storage (e.g., a shared folder through a cloud-based service) as a means for collecting information. This can not only make it difficult to track or control usage of the collected information, but also make it a challenge to ensure that the correct information is being collected from clients by secure means and used for stated purposes. In addition, legal data compliance regulations such as HIPAA and GDPR demand privacy and client's control of the submitted data, exposing the service provider to compliance liability.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a block diagram illustrating an example data system that includes a distributed data collection system, according to some embodiments.

FIG. 2 is a block diagram illustrating an example distributed data collection system, according to some embodiments.

FIG. 3 is a flowchart illustrating an example method for collecting data, according to some embodiments.

FIG. 4 is a flowchart illustrating an example method for collecting data, according to some embodiments,

FIG. 5 is a flowchart illustrating an example method for collecting data, according to some embodiments,

FIG. 6 is a flow diagram illustrating a distributed workflow, according to some embodiments.

FIG. 7 is a flow diagram illustrating a distributed workflow, according to some embodiments.

FIG. 8 depicts an interface diagram illustrating a graphical user interface to present a workflow status, according to some embodiments.

FIG. 9 depicts an interface diagram illustrating a workflow generation interface, according to some embodiments,

FIG. 10 is a block diagram illustrating a representative software architecture, which may be used in conjunction with various hardware architectures herein described, according to various embodiments of the present disclosure.

FIG. 11 is a block diagram illustrating components of a machine able to read instructions from a machine storage medium and perform any one or more of the methodologies discussed herein according to various embodiments of the present disclosure.

### DETAILED DESCRIPTION

A number of industries require the collection of information through expensive one-on-one exchanges between specialized subject-matter-experts, who are effectively selling their time and knowledge of a particular subject, to individuals seeking that expertise. Over time, the collection of information related to such industries has become exceedingly difficult in the current business environment, as many advisor/consultants and clients resort to using e-mail correspondence or shared data storage (e.g., a shared folder through a cloud-based service) as a means for collecting information. As discussed above, this not only makes it difficult to track the collection of such information, but also make it a challenge to ensure that the correct information is even being collected. In addition, certain compliance regulations define strict requirements for the control of the collected information, exposing service providers to compliance liability.

Various embodiments discussed herein describe an improved, distributed data collection system, which can enable subject matter experts to efficiently collect information from clients while remaining in full compliance with laws and regulations. According to certain example embodiments, the distributed data collection system enables a user (e.g., a subject matter expert) to define a data collection workflow process to divide a complex data collection method into a sequence of customizable, jointly-interactive interfaces (i.e., shared interfaces that include presentations of forms, which may be viewed and filled out simultaneously by multiple users, such as a subject matter expert and a client).

To facilitate joint-interaction with the presentations of the forms, the system presents a shared interface that include presentations of interactive forms simultaneously at multiple distinct devices. As discussed herein, a “shared interface” therefore refers to a graphical user interface (GUI), which may be displayed at a plurality of client devices simultaneously, and wherein inputs received into the GUI from any one or more of the plurality of client devices may be distributed and presented to the plurality of client devices. This distributed nature of data collection provides a user (e.g., a subject matter expert) with continuous control, visibility, and auditability of the provided data received from the client, for the purpose of retention.

In particular, some embodiments enable a user of the distributed data collection system to define a workflow as a series of customized interactive forms and associate the workflow with a unique workflow identifier. Certain embodiments of the distributed data collection system may cause display of one or more interfaces to define a workflow. For example, the interfaces may include functionality to provide various user inputs to define content of interactive forms, as well as a sequence of the interactive forms. In certain example embodiments, the interactive forms themselves may include questionnaires, wherein each interactive form among the series of interactive forms comprises a set of questions or fields to receive user inputs. The user may thereby author a series of interactive forms, and then provide an input to associate a workflow identifier to the series of interactive forms. In some embodiments, the user may also associate a customer or client account with the workflow.

Accordingly, in such embodiments, the distributed data collection system presents a workflow generation interface to receive inputs to define each interactive form of a workflow. The workflow generation interface may comprise a presentation of a form template, and one or more interface elements to be oriented at positions within the form template based on inputs received from the user, such as drag-and-drop. For example, a user of the distributed data collection system could generate an interactive form of a workflow, by providing an input that selects an interface element, and providing another input dragging and dropping the interface element at a position within the form template.

In some embodiments, in response to receiving the selection of the interface element, the distributed data collection system may generate and cause display of an interface to configure attributes of the interface element, such as text to be displayed within the interface element, one or more user selectable options of the interface element, display instructions for the interface element, and a display hierarchy of the interface element, wherein the display hierarchy defines a sequence of the interface element within the corresponding workflow.

In some embodiments, the user may provide further inputs to associate documents with responses to the interactive forms. For example, the interactive form may include a questionnaire that comprises a question or request for information, and one or more user input fields to receive a response to the question or request. The one or more user input fields may comprise a plurality of user options (e.g., multiple choice), a drop-down menu that comprises a user selectable list of options, as well as a field to receive a text based input. In certain embodiments, each of these responses may themselves be associated with one or more documents within a document repository such that the response itself references to the documents within a document library. Thus, by selecting a response, the distributed data collection system may retrieve a document associated with the response from the document library.

In some embodiments, a user (e.g., the subject matter expert or the client) provide inputs to define access permissions with each of the one or more documents, wherein access to a document from among the one or more documents is based on factors including user attributes and credentials, as well as temporal constraints. In such embodiments, the distributed data collection system displays a presentation of a document from among the one or more documents based on the access permissions specified by the user. For example, a user may provide a user input that specifies a list of user identifiers or user attributes necessary to view or otherwise access a document. Access may include viewing of the document, editing the document, and/or deleting the document. In further embodiments, the user may define a temporal period in which a document may be accessed or viewed.

Upon defining the one or more interactive forms of the workflow, the distributed data collection system receives a workflow identifier to assign to the workflow. By referencing the workflow identifier, the distributed data collection system identifies and retrieves the workflow from a database. In some embodiments, a user may associate the workflow with a customer account, such that referencing the customer account may also retrieve the workflow.

Responsive to defining the workflow, the distributed data collection system adds the corresponding workflow identifier to a list of workflow identifiers, wherein each workflow identifier corresponds to a particular series of interactive forms. Thus, to facilitate a distributed data collection session with a client, the subject matter expert may first login to a distributed data collection session, and responsive to authentication, be presented with an interface that comprises a presentation of the list of workflow identifiers. The subject matter expert may thereby provide an input that selects one or more of the workflow identifiers.

Responsive to receiving the input that selects the workflow identifier, the distributed data collection system first retrieves the corresponding series of interactive forms the questionnaire), and causes display of a distributed data collection interface that includes a display of a first interactive for u from among the series of interactive forms associated with the workflow, at both a first client device associated with the subject matter expert, and at a second client device associated with a client. According to certain embodiments, the distributed data collection interface may also comprise a presentation of one or more communication channels to enable the subject matter expert and client to interact during a data collection session. For example, the communication channels may include a video-chat interface, a chat window, as well as a dialogue transcript.

As discussed above, the distributed data collection system facilitates a “distributed” data collection session. As such, user inputs received from either node (i.e., the first client device or the second client device), may be shared and presented at both nodes simultaneously and in real-time. In some embodiments, the distributed data collection system may enable just one node to provide inputs into the interface at a given time, while in further embodiments, the inputs may be received simultaneously.

In response to receiving the responses to the interactive forms, the distributed data collection system accesses a document library to retrieve one or more documents based on the responses to the interactive forms of the workflow. For example, the document library may comprise a collection of documents, wherein each document within the document library is associated with one or more possible responses to the interactive forms of the workflow. The distributed data collection system compiles a questionnaire based on the documents retrieved from the document library and distributes the questionnaire to the customer (i.e., the second client device, or node discussed above).

In some embodiments, the distributed data collection system may identify recipients of the questionnaire based on the documents retrieved from the document library. For example, the documents within the document library may have associated document attributes that define a document type. A user may define a reference list that comprises a list of user identifiers and corresponding document types, such that the distributed data collection system may identify one or more user identifiers from the reference list based on a document type.

As an illustrative example from a user perspective, a subject matter expert (e.g., a first user), and a customer (e.g., a second user) access a distributed data collection system, simultaneously and in real-time via respective client devices. The subject matter expert defines a workflow through one or more user inputs into a graphical user interface (GUI). For example, the subject matter expert may provide user inputs to define a decision tree, wherein each node of the decision tree comprises a request for information from the customer. Upon defining a workflow, the subject matter expert assigns a workflow identifier to the workflow, and saves the workflow to a workflow database.

To initiate a communication session with the customer, the subject matter expert selects a workflow from among a selection of workflows retrieved from a database. Each workflow may include a first questionnaire that comprises a sequence of interactive forms, wherein portions of the sequence are displayed successively and in real-time based on responses received from a customer. In response to receiving the selection of the workflow, the distributed data collection system generates and causes synchronized display of a portion of the sequence of interactive forms within a GUI at the respective client devices of the subject matter expert and the customer. In some embodiments, the distributed data collection system may facilitate real-time two-way communication between the subject matter expert and the customer (e.g., teleconference, chat window, video chat).

As the customer or subject matter expert provides user inputs into the interactive forms, the distributed data collection system displays successive portions of the interactive forms from the workflow, based on the decision tree defined by the subject matter expert. For example, in response to receiving a user input into a first interactive form of the workflow, the distributed data collection system identifies and displays a second interactive form from among the sequence of interactive forms, based on the user input of the customer.

In some embodiments, the distributed data collection system tracks interactions with workflows. For example, in response to receiving a selection of a workflow by a subject matter expert, the distributed data collection system generates and updates a record of user inputs and interactions with the workflow, wherein the record includes identifications of users (e.g., user identifiers), as well as time-stamps, and indications of what inputs were made. For example, the record may comprise a chronological list of inputs into the workflow, with identifications of a user which provided the inputs.

Upon completing the form, one or both of the customer and the subject matter expert may provide an input indicating that the form is complete. In response to receiving the input, the distributed data collection system presents a notification to the subject matter expert and the customer, wherein the notification includes an identification of the workflow, and an option to review the interactive forms of the workflow. For example, a user (e.g., the subject matter expert) may provide an input selecting the option of the notification and, in response the distributed data collection system, may generate and cause display of a presentation of the one or more interactive forms of the workflow, with corresponding responses received from the customer.

In some embodiments, the subject matter expert provides an input identifying one or more deficiencies, discrepancies, or errors among the responses to the interactive forms provided by the customer. For example, based on the review of the completed interactive forms, the subject matter expert may flag one or more responses to the interactive forms received from the customer. In response to receiving the inputs flagging the responses, the distributed data collection system generates and causes display of a notification to the customer, wherein the notification provides an indication of which responses are incorrect or incomplete. The customer may thereby provide inputs rectifying the errors. In response to receiving the updated responses, the distributed data collection system presents a notification to the subject matter expert.

In some embodiments, the indication that the form is complete may include a review of the sequence of forms to determine that all the requested information has been provided by the customer. In response to determining that the workflow has been completed, the distributed data collection system receives responses to the interactive forms (e.g., user inputs) from the customer, and stores the responses in a memory location associated with an identifier of the customer.

The subject matter expert may determine, at a later time, that new forms must be filled out by the customer (e.g., based on new laws, or a change to a business of the customer). The subject matter expert may alter the workflow through the addition of new interactive forms, or by associating new documents to responses of the customer. In response to receiving an indication that new forms or documents have been added to the workflow or to the document library, the distributed data collection system causes display of a notification to the customer and to the subject matter expert, to schedule a new interview to update the responses of the customer based on the new interactive forms or documents. In some embodiments, the distributed data collection system may generate and distribute a meeting invitation to the customer and the subject matter expert.

The distributed data collection system receives the indication that the workflow has been completed by the customer, and in response, accesses the memory location and retrieves the responses to the interactive forms. The distributed data collection system generates a second questionnaire based on the responses to the workflow. To generate the second questionnaire, the distributed data collection system retrieves one or more documents from a document library, based on the responses to the interactive forms, and compiles the second questionnaire based on the one or more documents. In response to generating the second questionnaire, the distributed data collection system identifies one or more recipients of the second questionnaire (e.g., based on the documents and a user profile of the customer), and distributes the second questionnaire to the recipients. The recipients may thereby provide responses to the documents of the second questionnaire.

The distributed data collection system compiles the responses to the second questionnaire, and transmits the compiled responses to the subject matter expert. In some embodiments, the distributed data collection system generates and presents a notification at the client device of the subject matter expert based on the compiled responses. The subject matter expert reviews the compiled responses to determine if everything is accurate and complete. Upon identifying an area that requires additional information, the subject matter expert may flag the one or more affected documents. In response to detecting the flag on the one or more documents, the distributed data collection system causes display of a notification at the client device of the customer. For example, the subject matter expert may provide a message that describes what additional information is needed, and the distributed data collection system may display the message in the notification.

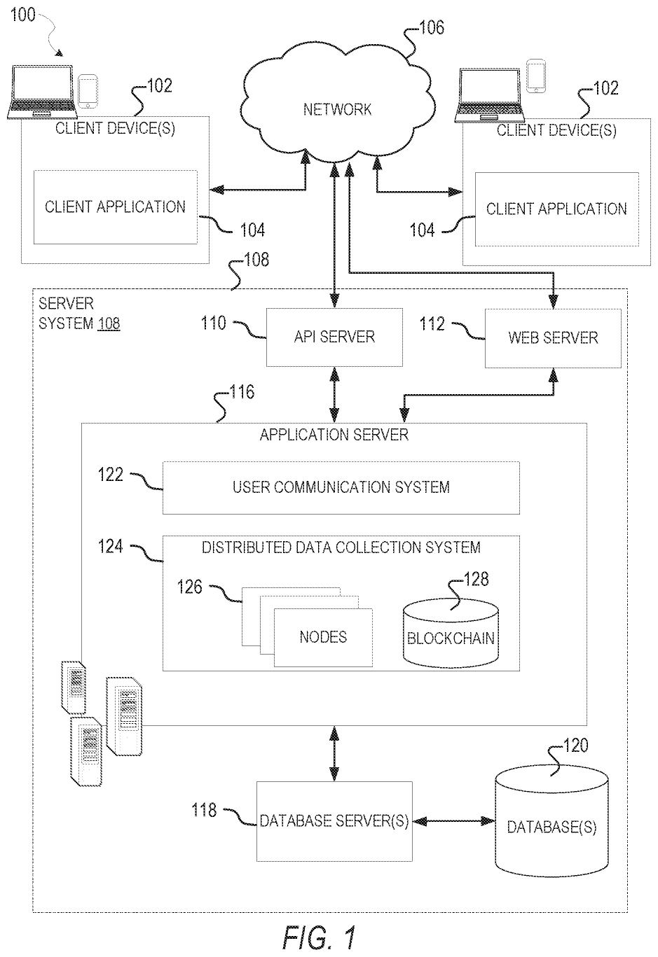

FIG. 1 is a block diagram illustrating an example data system 100 that includes a distributed data collection system 124, according to some embodiments. By including the distributed data collection system 124, the data system 100 can enable data object collection, management, tracking, permission control, licensing, or some combination thereof, by one or more client devices 102. As shown, the data system 100 includes multiple client devices 102, a server system 108, and a network 106 (e.g., including Internet, wide-area-network, local-area-network, wireless network, etc.) that communicatively couples them together. Each client device 102 can host a number of applications, including a client application 104. Each client application 104 may communicate data with one or more other instances of the client application 104, or with the server system 108 via a network 106.

Accordingly, each client application 104 can communicate and exchange data with another client application 104 and with the server system 108 via the network 106. The data exchanged between the client applications 104, and between a client application 104 and the server system 108 could include, without limitation, data objects, requests, responses, public/private keys, hash values, access rights data, license data, and authentication data.

The server system 108 provides server-side functionality via the network 106 to a particular client application 104. While certain functions of the data system 100 are described herein as being performed by the distributed data collection system 124 on the server system 108, it will be appreciated that the location of certain functionality within the server system 108 is a design choice. For example, it may be technically preferable to initially deploy certain technology and functionality within the server system 108, but to later migrate this technology and functionality to the client application 104 where a client device 102 provides enhanced data object functionality.

The server system 108 supports various services and operations that are provided to the client application 104 by the user communication system 122 and the data collection system 124. Such operations include transmitting data from the distributed data collection system 124 to the client application 104, receiving data from the client application 104 to the data collection system 124, and the distributed data collection system 124 processing data generated by the client application 104. This data may include for example, data objects, requests, responses, public/private keys, hash values, access rights data, license data, and authentication data. Data exchanges within the data system 100 may be invoked and controlled through functions available via an application program interface (API), or one or more user interfaces (UIs) of the client application 104, which may include web-based UIs provided by the server system 108 for presentation at the client device 102.

With respect to the server system 108, an API server 110 is coupled to, and provides a programmatic interface to, an application server 116, which hosts the user communication system 122 and the data collection system 124. The application server 116 is communicatively coupled to a database server 118, which facilitates access to a database 120 that stores data associated with the application server 116.

The API server 110 receives and transmits data (e.g., API calls, commands, data objects, requests, responses, public/private keys, hash values, access rights data, license data, and authentication data) between the client device 102 and the application server 116. Specifically, the API server 110 provides a set of interfaces (e.g., routines and protocols) that can be called or queried by the client application 104 in order to invoke functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); interview sessions functionality; business process operations (e.g., starting, generating, etc.); user communications; and calendar functionality.

The application server 116 hosts a number of applications and subsystems, including a user communication system 122 and the distributed data collection system 124 with a blockchain 128. The user communication system 122 implements a number of message processing technologies and functions, including exchanging messages between multiple instances of the client application 104. The user communication system 122 may facilitate user messaging in conjunction with other operations of the data collection system 124. For some embodiments, the user communication system 122 supports message threads, where a plurality of users may exchange messages (e.g., in connection with entering information into an electronic form).

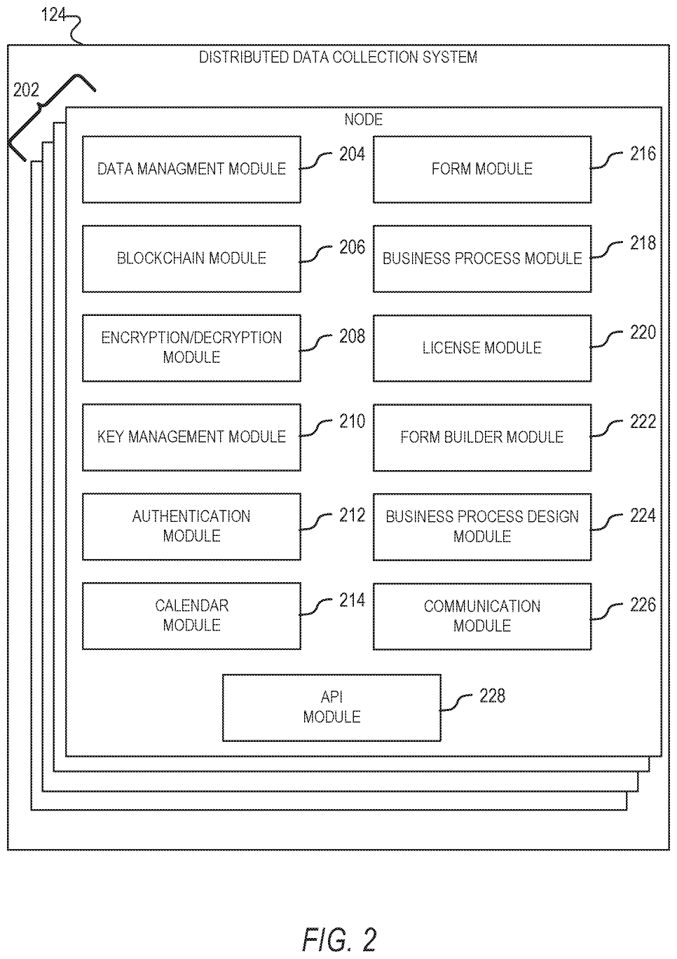

The application server 116 also includes the distributed data collection system 124, which supports various functions and services with respect to various embodiments described herein. For instance, the distributed data collection system 124 may support data object collection, management, tracking, or control with respect to one or more instances of the client applications 104. As shown, the distributed data collection system 124 may comprise multiple nodes 126 and the blockchain 128, where each of the nodes 126 is associated with a particular user and each particular user controls their respective data objects through their associated node, and each of the nodes may access the blockchain 128 to perform operations described herein. In this way, each of the node 126 can effectively serve as a computer container for storing data objects associated with the particular user, and further for supporting one or more functions (e.g., collection, management, tracking, or control functions) with respect to the data objects associated with the particular user. Though more than one node is illustrated with respect to the data collection system 124, for some embodiments, the distributed data collection system 124 supports a single node 126 and interacts with another node 126 supported by a separate data collection system 124. For instance, a client user's node may be supported by a distributed data collection system 124 that is on-premise with respect to the client user, and a subject matter expert (SME) user's node may be supported by a distributed data collection system 124 that is hosted on a cloud-based computer platform. More regarding various embodiments of a data collection system are described with respect to FIG. 2.

The application server 116 is communicatively coupled to a database server 118, which facilitates access to a database 120 in which may be stored data associated with the user communication system 122, the data collection system 124, or both. Though the blockchain 128 is shown as a separate entity from the database 120, for some embodiments, the blockchain 128 may be implemented (at least in part) by the database 120.

FIG. 2 is a block diagram illustrating an example distributed data collection system 124 with a blockchain, according to some embodiments. As shown, the data collection system 124 comprises two or more nodes 202, where each of the nodes 202 includes a data management module 204, a blockchain module 206, an encryption/decryption module 208, a key management module 210, an authentication module 212, a calendar module 214, a form module 216, a business process module 218, a license module 220, a form builder module 222, a business process design module 224, a communication module 226, and an API module 228. For various embodiments, the components and arrangement of components may vary from what is illustrated in FIG. 2. For instance, a node 202 of the data collection system 124 can include more or fewer components than the components shown in the FIG. 2.

As noted herein, a particular node 202 may be associated with a particular user, which permits the particular user to interact (e.g., participate) with the data collection system 124 in accordance with various embodiments described herein. For some embodiments, each node of the data collection system 124 includes its own instance of the modules 204-228. Additionally, by way of its own instance of the blockchain module 206, a node of the data collection system 124 may access a blockchain that is commonly accessed by one or more other nodes of the data collection system 124, thereby facilitating various operations described herein.

The data management module 204 may facilitate or support management and storage of a data object with respect to a data storage device associated with a particular node 202-1 of the nodes 202. For example, the data management module 204 may include, or interface with, a data management system that is associated with or included by the node 202-1. The data storage device associated with the node 202-1 may comprise one that is included as part of the node 202-1, or one that external to the node 202-1 but coupled to the node 202-1 (e.g., by way of a network connection). The data storage device associated with the node 202-1 may be one that stores data for a number of the nodes 202 of the data collection system 124, but in compartmentalized data spaces dedicated to individual nodes 202. For example, the data storage device may comprise data space for the node 202-1 on a distributed storage system. For the node 202-1, the data management module 204 can facilitate storage of a data object, removal of the data object, or transfer of the data object from the node 202-1 to another node (e.g., node 202-2), which may be facilitated by a peer-to-peer transfer between the two nodes respective data management systems.

The blockchain module 206 may facilitate or support access by the node 202-1 with respect to a blockchain. As used herein, access to the blockchain can include writing data (e.g., adding a data block) to the blockchain or reading data from the blockchain.

The encryption/decryption module 208 may facilitate or support encryption and decryption of data on the node 202-1, such as data objects, requests, responses, and the like.

The key management module 210 may facilitate or support storing and managing (e.g., within a key vault) one or more keys associated with the node 202-1, such as a private key of the node 202-1, a public key of the node 202-1, or a key of a data object associated with (e.g., stored with respect to) the node 202-1. The key management module 210 may also facilitate or support generation of a key at the node 202-1, may retrieve a key from another node, or provide a key to another node. For some embodiments, one or more public keys of the node 202-1 are stored on the blockchain as well to facilitate usage of public/private cryptography when communicating data objects between nodes, as described herein.

The authentication module 212 may facilitate or support authentication of a user of the node 202-1 based on user-provided credentials, such as username, password, biometric information, a physical token (e.g., smart card), or the like. To facilitate authentication, the authentication module 212 may interact with an authentication device or server external to the node 202-1. Depending on the embodiment, the authentication module 212 may be used to authenticate a user during a login process, when a user sends a request, or when a user responds to a request (e.g., a user on node 202-1 approves a request from a user on another node).

The calendar module 214 may facilitate or support, on the node 202-1, calendar operations with respect to the node 202-1, which may include creating or setting calendar events, reminders or deadlines with respect to collection of information (e.g., using electronic forms during an interview session) from users associated with the nodes 202.

The form module 216 may facilitate or support, on the node 202-1, retrieving, loading (e.g., opening), storing, or updating an electronic form. For some embodiments, the form module 216 verifies that the electronic form being served for use in collection of data from a client user is current and identical as defined by a SME user. Additionally, for various embodiments described herein, an electronic form and data collected using that electronic form can represent a single data object. In this way, where the electronic form is updated (e.g., new version of electronic form created), the version of the electronic form used to originally collect data continues to be associated with that data collected.

The business process module 218 may facilitate or support, on the node 202-1, retrieving, loading, performing (e.g., launching or starting), storing, or updating a business process defined by a business process object. An example of a business process object may include, without limitation, a data object containing data relating to a business process model notation (BPMN) model. Example functions or operations defined by the BPMN model for use in a business process include, without limitation, approval, rejection, export, payment, fax, and the like.

The license module 220 may facilitate or support, on the node 202-1 creating, retrieving, loading, generating, updating, or enforcing license data, which may be associated with a data object (e.g., pre-existing data object) used to generated new data objects, such as a new electronic form (e.g., via the form builder module 222) or a new business process data object (e.g., via the business process designed module).

The form builder module 222 may facilitate or support generating a new electronic form, which may or may not be generated based on an existing data object (e.g., licensable data object having associated license data). The existing electronic form may be available through a catalog or store of predesigned or prebuilt data objects supported by the data collection system 124 and accessible by one or more of the nodes 202. For some embodiments, the form builder module 222 permits a first user (e.g., SME user) to generate an electronic form that collects appropriate data from a second user (e.g., client user) in accordance with the data collection requirements that the first user is attempting to fulfill (e.g., as part of a service rendered by the first user to the second user). The data collection requirements may he determined by a decision tree generated by the first user (e.g., the SME user) using their knowledge, design, and flow. Accordingly, the first user (e.g., the SME user) can generate an electronic form using their knowledge, design, and flow, for collection of data from the second user, without resorting to creation of computer code.

The business process design module 224 may facilitate or support generating a new business process object defining a business process. The business process design module 224 may generate the new business process object based on an existing business process object (e.g., licensable data object having associated license data). The existing business process object may be available through a catalog or store of predesigned or prebuilt data objects supported by the data collection system 124 and accessible by one or more of the nodes 202.

The communication module 226 may facilitate or support communications between users on two or more of the nodes 202. For example, the communication module 226 may include or integrate with a team collaboration tool. The communication between the users may include, without limitation, user to user messages, message threads, chat rooms, audio, video, and the like.

The API module 228 may facilitate or support receiving and responding to API calls received by the node 202-1, where such API calls may be received by a software application that is operating on the node 202-1 or external to the node 202-1.

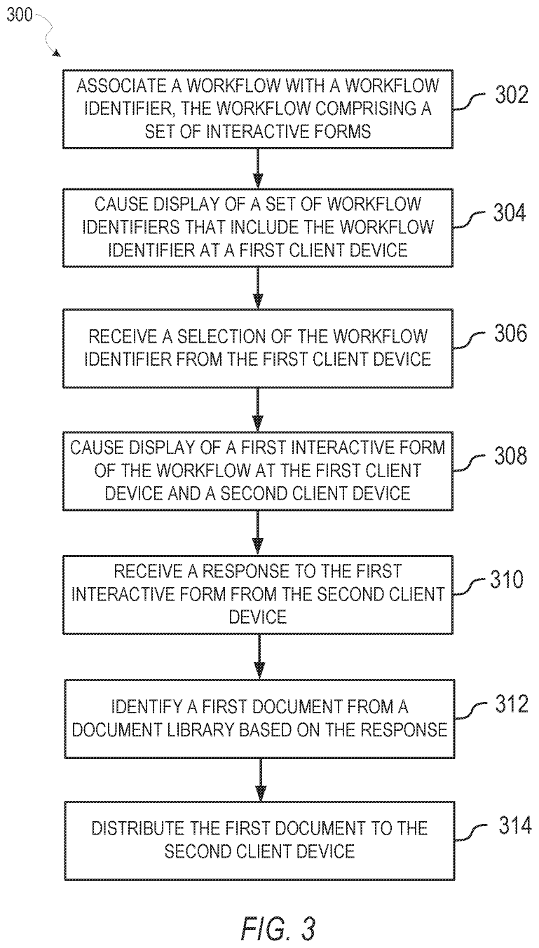

FIG. 3 is a flowchart illustrating a method 300 for collecting, data, according to some embodiments. It will be understood that example methods described herein may be performed by a machine in accordance with some embodiments. For example, the method 300 may be performed by a node of an embodiment, such as a node 202 of the distributed data collection system 124. An operation of various methods described herein may be performed by a hardware processor (e.g., a central processing unit or graphics processing unit) of a computing device (e.g., a desktop, server, laptop, mobile phone, tablet, etc.), which may be pail of a computing system based on a cloud architecture. Example methods described herein may also be implemented in the form of executable instructions stored on a machine-readable medium or in the form of electronic circuitry. For instance, the operations of a method 300 of FIG. 3 may be represented by executable instructions that, when executed by a processor of a computing device, cause the computing device to perform the method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to the FIG. 3, the method 300 may be performed by a first node, which may be one of the nodes 202 of the data collection system 124. As shown, the method 300 begins with operation 302, where the distributed data collection system 124 associates a workflow (e.g., generated by a user) with a workflow identifier, wherein the workflow comprises a set of interactive forms and an associated decision tree hierarchy. For example, each form among the set of forms may be associated with one another based on the decision tree hierarchy, such that the sequence and displayed portions of the set of forms are determined based on one or more responses received from a user accessing the forms.

At operation 304, the distributed data collection system 124 causes display of a set of workflow identifiers that include the workflow identifier at a first client device (e.g., client device 102), wherein the first client device is associated with a subject matter expert. At operation 306, the subject matter expert provides an input selecting the workflow identifier associated with the workflow from among the set of workflow identifiers.

In some embodiments, the subject matter expert may associate a workflow identifier with a user identifier of a customer, or a particular customer attribute (e.g., a customer type). In such embodiments, to select an appropriate workflow identifier, the subject matter expert may provide an input that identifies the user identifier or the customer attribute, and in response, the distributed data collection system 124 retrieves the workflow that corresponds with the workflow identifier associated with the user identifier or customer attribute.

For example, a customer attribute may include a “customer type,” that may include a business category. In such embodiments, the distributed data collection system 124 may cause display of an interface that comprises a presentation of various customer attributes (e.g., medical professional, venture capitalist, small business owner, etc.). The subject matter expert may provide an input selecting one or more attributes from the interface and in response, the distributed data collection system 124 may retrieve the appropriate corresponding workflow.

In response to receiving the selection of the selection of the workflow identifier, at operation 308, the distributed data collection system 124 generates and causes display of a portion of the workflow (e.g., a first interactive form), at the first client device associated with the subject matter expert, and at a second client device (e.g., client device 102), wherein the second client device is associated with a second user (e.g., a customer).

At operation 310, the distributed data collection system 124 receives a response to the first interactive form from the second user. For example, the second user may provide an input selecting an option presented from the first interactive form.

In some embodiments, the distributed data collection system 124 retrieves prior responses to the first interactive form (as well as the set of interactive forms associated with the workflow), based on a user identifier of the customer. For example, the distributed data collection system 124 may store historical responses to the one or more interactive forms of the workflow at a memory location associated with the user identifier of the customer. In response to initiating a communication session between the customer and the subject matter expert, the distributed data collection system 124 accesses the memory location to retrieve historical responses to the one or more interactive forms of the workflow, based on the user identifier of the customer, and populates the one or more interactive forms (including the first interactive form) based on the prior historical responses.

At operation 312, the distributed data collection system 124 identifies a document (e.g., a first document) from among a collection of documents stored within a document library, based on the response to the first interactive form received from the second user.

In some embodiments, the document may include a document due date. Responsive to determining that the document includes a due date, the distributed data collection system 124 generates a calendar event based on the due date, wherein the calendar event may distribute notifications to the first client device and the second client device at time intervals based on the due date. For example, the notifications may include an identification of the document and a presentation of the due date.

At operation 314, the distributed data collection system 124 distributes the document to the second client device. The document may include a questionnaire that comprises a set of questions requiring input from the customer. In some embodiments, the distributed data collection system 124 compiles one or more documents retrieved from the document library into a questionnaire to he presented to the customer.

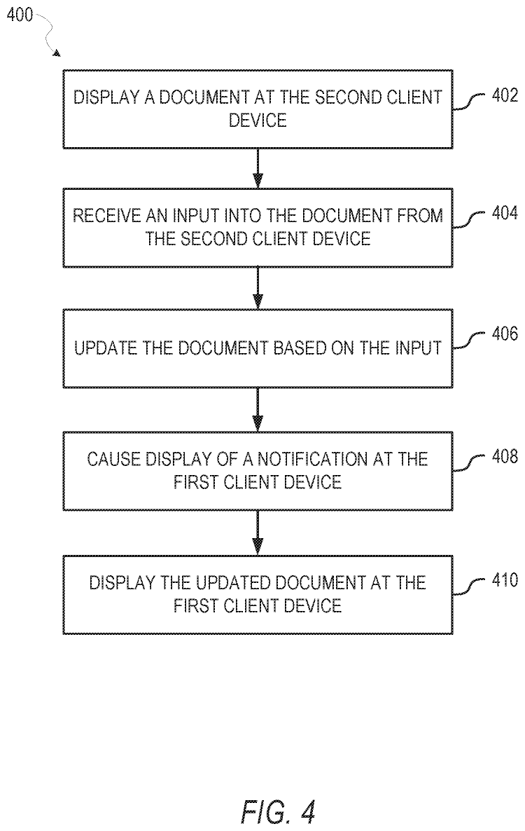

FIG. 4 is a flowchart illustrating a method 400 for collecting data, according to some embodiments. It will be understood that example methods described herein may be performed by a machine in accordance with some embodiments. For example, the method 400 may be performed by a node of an embodiment, such as a node 202 of the distributed data collection system 124. An operation of various methods described herein may be performed by a hardware processor (e.g., a central processing unit or graphics processing unit) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of a method 400 of FIG. 4 may be represented by executable instructions that, when executed by a processor of a computing device, cause the computing device to perform the method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to the FIG. 4, the method 400 may be performed by a first node, which may be one of the nodes 202 of the distributed data collection system 124. As shown, the method 400 begins with operation 402, where the distributed data collection system 124 displays a document retrieved from a library of documents at a second client device. The operation 402 may be performed as a subroutine of the operation 314 of the method 300, as depicted in FIG. 3.

At operation 404, the distributed data collection system 124 receives an input into the document from the second client device. As discussed above, at operation 314 of FIG. 3, the document includes a questionnaire that comprises a set of questions requiring inputs from the customer. For example, the set of questions may include requests for documents (e.g., PDF) or specific user inputs (e.g., text inputs).

At operation 406, the distributed data collection system 124 updates the document based on the inputs from the second client device, at a memory location associated with the customer.

At operation 408, a notification is displayed at the first client device (e.g., of the subject matter expert) in response to detecting the update to the document at the memory location associated with the customer. The notification may include an identification of the customer (e.g., a user identifier), and an indication of the document which was updated by the input. In some embodiments, the subject matter expert may provide an input into the notification which causes the distributed data collection system 124 to retrieve the document from the memory location associated with the customer.

At operation 410, the updated document (based on the input from the second client device) is displayed at the first client device, wherein the subject matter expert may review the updated document. In some embodiments, the subject matter expert may provide an input to either accept or reject the inputs provided by the customer.

For example, if the subject matter expert accepts the input into the document from the customer, the updated document is indexed and stored at a separate memory location, and a notification is delivered to the second client device notifying them that the document has been approved and is completed.

Alternatively, if the subject matter expert rejects the input into the document from the customer, the distributed data collection system presents a notification at the second client device that includes a request to revise the input. In some embodiments the subject matter expert may additionally include comments and feedback which may be displayed within the notification.

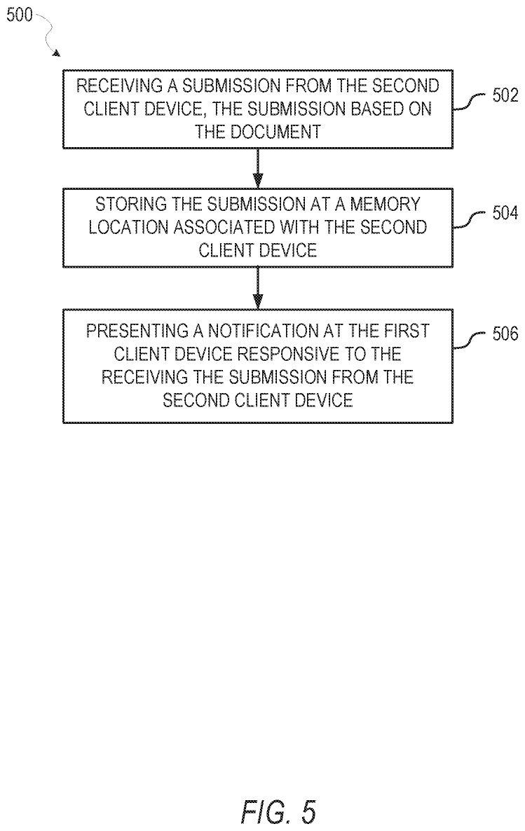

FIG. 5 is a flowchart illustrating a method 500 for collecting data, according to some embodiments. It will be understood that example methods described herein may be performed by a machine in accordance with some embodiments. For example, the method 500 may be performed by a node of an embodiment, such as a node 202 of the distributed data collection system 124. An operation of various methods described herein may be performed by a hardware processor (e.g., a central processing unit or graphics processing unit) of a computing device (e.g., a desktop, server, laptop, mobile phone, tablet, etc.), which may be part of a computing system based on a cloud architecture. Example methods described herein may also be implemented. In the form of executable instructions stored on a machine-readable medium or in the form of electronic circuitry. For instance, the operations of a method 500 of FIG. 5 may be represented by executable instructions that, when executed by a processor of a computing device, cause the computing device to perform the method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

In some example embodiments, operations of the method 500 may be performed as a sub-routine of the method 400, described in FIG. 4 above. For example, responsive to receiving the input into the document from the second client device, and updating the document based on the input, as in operations 406 and 408, at operation 502 the distributed data collection system 124 receives a submission from the second client device. The submission may for example comprise a packet that includes the document and the inputs received from the second client device into the document.

For example, the document may include an interactive form that comprises a plurality of input fields to receive text inputs. A user of the second client device may provide one or more inputs that include text data into the plurality of input fields. The submission from the second client device may therefore comprise a populated copy of the document that includes the inputs received from the second client device.

At operation 504, responsive to receiving the submission from the second client device, the distributed data collection system 124 stores the submission at a memory location (e.g., within the database 120) associated with the second client device. For example, in some embodiments, storing the submission from the second client device may include generating a hash based on the submission, and recording the hash on a blockchain at the database 120.

At operation 506, responsive to storing the submission at the memory location, the distributed data collection system 124 generates and causes display of a notification at the first client device, wherein the notification includes an identification of the second client device and the document. A user of the first client device may thereby provide inputs to retrieve and review the document.

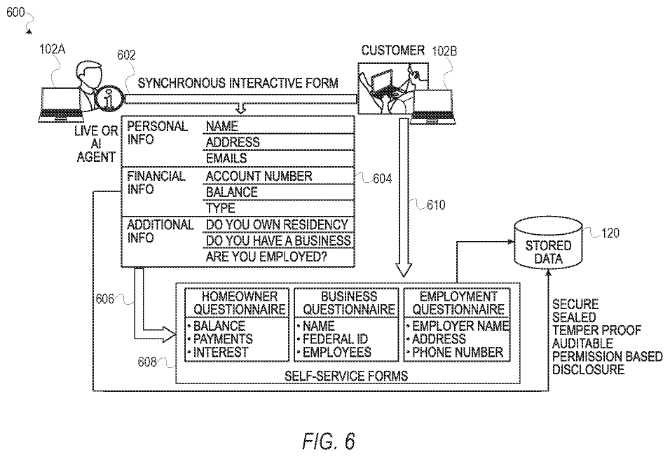

FIG. 6 is a flow diagram illustrating a distributed workflow 600, according to some embodiments. The distributed workflow 600 is depicted in FIG. 6 as an ordered sequence of operations, starting at operation 602, wherein a synchronous interactive form 604 is displayed at a first client device 102A associated with a subject matter expert, and at a second client device 102B associated with a second user (e.g., a customer).

For example, as depicted in the method 300 depicted in FIG. 3, the synchronous interactive form may be displayed at the client device 102A and the client device 102B responsive to an input that selects a workflow identifier, or based on an identifier (e.g., a user identifier, or a device identifier) associated with the second user of the second client device 102B. As discussed in operations 304, 306, and 308 of the method 300, the synchronous interactive form 604 may be retrieved by the distributed data collection system 124 based on the workflow identifier, and displayed at the client device 102A and 102B simultaneously.

According to some embodiments, the synchronous interactive form 604 may comprise a display of one or more input fields configured by the distributed data collection system 124 to receive user inputs that include selections of options, or text inputs. Some of the user input fields may comprise a presentation of a set of user selectable options that include requests for a binary response (e.g., yes or no), while other user input fields may comprise a text field to receive a text input from the client devices 102A or 102B. Inputs received into the synchronous interactive form 604 may thereby be presented within the synchronous interactive form 604 at the client device 102A and 102B simultaneously and in real-time.

In some embodiments, the distributed data collection system 124 retrieves prior responses to the synchronous interactive form 604 based on an identifier associated with the second client device 102B. For example, the distributed data collection system 124 may store historical responses to the one or more user input fields displayed within the synchronous interactive form 604 at a memory location associated with the identifier at a database 120. In such embodiments, responsive to initiating a communication session between the first client device 102A and second client device 102B, the distributed data collection system 124 accesses the database 120 to retrieve historical responses to the one or more user input fields of the synchronous interactive form 604 and populates the one or more user input fields of the synchronous interactive form 604 based on the prior historical responses.

At operation 606, the distributed data collection system 124 identifies a set of documents 608, from among a collection of documents stored within a document library, based on the response to the one or more user input fields presented in the synchronous interactive form 604.

As depicted in operation 314 of the method 300 of FIG. 3, the distributed data collection system 124 distributes and causes display of a presentation of the set of documents 608, wherein each document from among the set of documents 608 comprises a set of questions requiring user inputs. For example, in some embodiments, the distributed data collection system 124 compiles the set of questions from the set of documents 608 into a single document to he presented at the client device 102B.

At operation 610, the distributed data collection system 124 receives inputs from the client devices 102B responding to the set of questions of the set of documents 608, and records the inputs responding to the set of set of questions at a memory location associated with an identifier that corresponds with the client device 102E (e.g., a user identifier or a device identifier), at the database 120.

In some embodiments, responsive to receiving the inputs responding to the set of questions, the distributed data collection system 124 presents a notification at the first client device 102A, wherein the notification includes an identification of the second user of the second client device 102B, and an indication of the documents that were updated based on the inputs. The first user of the first client device 102A may provide inputs into the notification to cause the distributed data collection system 124 to retrieve the document or documents from the memory location associated with the identifier that corresponds with the second client device 102B from the database 120.

According to certain example embodiments, inputs received from the client device 102B, as in operations 606 and 610, are recorded at the database 120 using a blockchain (e.g., the blockchain 128). As used herein, a blockchain comprises a data structure that stores a series of linked data blocks, where a data block in the series is linked to a prior block in the series, and comprises both a timestamp of blockchain creation, as well as a hash (e.g., cryptographic hash of the contents) of the prior data block in the series of linked data blocks. In this way, the blockchain provides a chain of data blocks which cannot individually be modified or changed without impacting or comprising the integrity of the entire chain.

In some embodiments the database 120 may comprise an electronic ledger that maintains a secure, historical record of data transactions relating to data objects (e.g., information regarding the source or destination of a data object transaction), based on the blockchain. As an electronic ledger, the database 120 may use the blockchain to function as a “distributed” ledger, wherein data within the database 120 may be accessed by two or more nodes, wherein, a node may comprise a single physical machine (e.g., single server, or a single client device) or a single virtual machine. For example, a node may comprise a single client device, a single server, or a virtual machine residing in a cloud-computing environment.

Some embodiments of the database 120 described herein may add one more new data blocks to a blockchain to store data on the blockchain. For example, a data object, a hash of a data object, metadata regarding a data object, a public/private key used in performing data object transactions, or some combination thereof. For some embodiments, a plurality of nodes can access a common blockchain within the database 120 when performing data object functions described herein. Though the blockchain may be accessible by two or more nodes of an embodiment, one or more data objects stored on the blockchain may be encrypted before being stored on the blockchain as one or more data blocks, ensuring that only those nodes associated with authorized users (e.g., those nodes having appropriate access rights or public keys) can access the encrypted data objects stored within the database 120 on the blockchain. Depending on the embodiment, the database 120 may he stored on a single or distributed datastore. For some embodiments, each node (e.g., client node) may be associated with its own blockchain within the database 120.

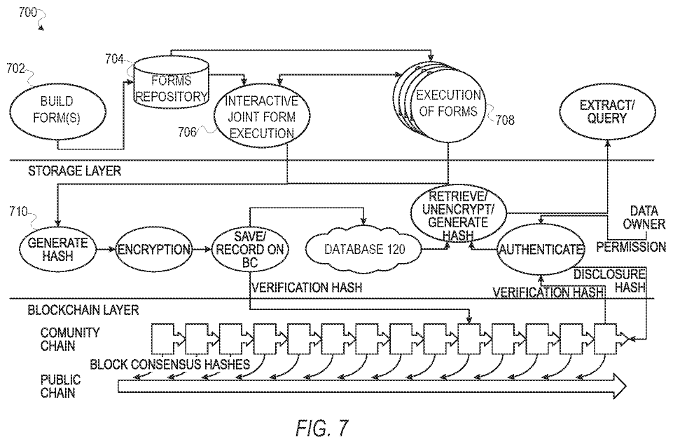

FIG. 7 is a flow diagram 700 illustrating a distributed workflow, according to some embodiments. The flow diagram 700 depicts one or more operations to be performed by the distributed data collection system 124, as described in FIGS. 3, 4, and 5 above.

As seen in the flow diagram 700, a distributed workflow may begin at operation 702, wherein one or more modules of the distributed data collection system 124 builds one or more jointly interactive forms. For example, the form builder module 222 depicted in FIG. 2 may facilitate or support generating one or more new interactive electronic forms, which may be generated based on an existing data object (e.g., licensable data object having associated license data), located within a forms repository 704, which may be a part of the databases 120. According to such embodiments, the existing data object may be available through a catalog or store of predesigned or prebuilt data objects supported by the distributed data collection system 124, and accessible by one or more of the nodes 202, as depicted in FIG. 2.

In some example embodiments, the form builder module 222 permits a first user (e.g., a subject matter expert at a client device 102A) to generate an electronic form that provides one or more interactive fields to receive data as inputs from a second user (e.g., a user of client device 102B) in accordance with the data collection requirements that the first user is attempting to fulfill (e.g., as part of a service rendered by the first user to the second user).

At operation 706, as described in operation 308 of the method 300 depicted in FIG. 3, the distributed data collection system 124 facilitates interactive joint execution of the one or more forms generated by the form builder module 222 and generates and simultaneously causes display of at least a portion of a first interactive form at a first client device 102A, and a second client device 102B. The distributed data collection system 124 receives inputs into the one or more forms at operation 606.

At operation 708, based on the inputs received into the one or more forms at operation 706, the distributed data collection system identifies a document (e.g., a first document) from among a collection of documents stored within a database 120 based on the response received at operation 706, and distributes the document to the second client device 102B. For example, the document may include a questionnaire that comprises a set of questions requiring further inputs from the customer. In some embodiments, the distributed data collection system 124 compiles one or more documents retrieved from the document library into a questionnaire to be presented to the customer.

At operation 710, responsive to operations 706 and 708, the distributed data collection system 124 records and stores the one or more forms, and the inputs received into the for us within the database 120. According to certain embodiments discussed herein, storing the forms and inputs within the database 120 may include storing the forms and inputs using a blockchain. As seen in the flow diagram 700, operation 710 may be performed by generating a hash, encrypting the hash, and storing the encrypted hash using the blockchain as a verification hash.

As discussed above, the blockchain comprises a data structure that stores a series of linked data blocks, where a data block in the series is linked to a prior block in the series, and comprises both a timestamp of blockchain creation, as well as a hash (e.g., cryptographic hash of the contents) of the prior data block in the series of linked data blocks. Thus, according to such embodiments, each encrypted hash may correspond to a distinct linked data block among the series of linked data blocks that make up the blockchain.

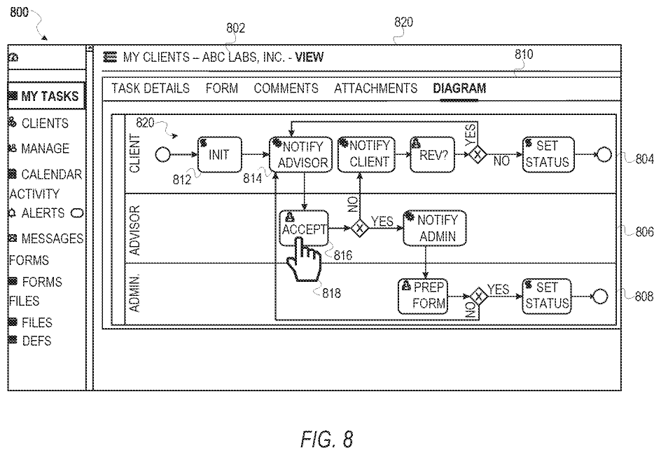

FIG. 8 depicts an interface diagram 800 illustrating a GUI 820 to present a workflow status, according to some embodiments. In some embodiments, the distributed data collection system 124 tracks and presents a visualization of a status of a workflow. For example, as seen in FIG. 8, the GUI 820 may include a display of a client identifier 802 at a position within the GUI 820, and a presentation of a visualization of a workflow status 810 associated with the client identified by the client identifier 802.

As seen in the interface diagram 800, the presentation of the workflow status 810 may include a display of a set of graphical icons 820 at positions within the GUI 820, wherein each graphical icon among the set of graphical icons 814 corresponds with an input or user interaction associated with the client identified by the client identifier 802, and wherein the position of the graphical icon within the GUI 820 indicates a source of the input (e.g., row 804, row 806, and row 808). For example, graphical icon 816 identifies a particular workflow status and is displayed in the row 806, which corresponds with an advisor.

As an illustrative example, a client (e.g., ABS Labs), may initiate a workflow by providing inputs into an interactive form. Responsive to the initiations of the workflow by the client, the distributed data collection system 124 records the initiation of the workflow and displays the first graphical icon 812 along the row 804 in the GUI 820.

Later, as the client continues working through the documents of the workflow, the client may provide another input to notify an advisor that the documents have been completed. In response to receiving the input from the client indicating that the documents of the workflow have been completed, the distributed data collection system 124 causes display of the second graphical icon 814 in the row 804.

Responsive to receiving the input indicating that the documents of the workflow have been completed, the distributed data collection system 124 presents a notification to an advisor associated with the workflow, requesting review of the corresponding documents. The advisor may thereby be presented with the documents and provide an input either accepting or rejecting the documents. Based on the input from the advisor, the distributed data collection system causes display of the graphical icon 816 along the row 806.

In some embodiments, a user may provide an input selecting a graphical icon, such as the input 818, and in response, the distributed data collection system 124 may cause display of details of a user interaction that corresponds with the graphical icon selected. For example, the details may include a timestamp. identifications of users (e.g., user identifiers), as well as indications of what inputs were made.

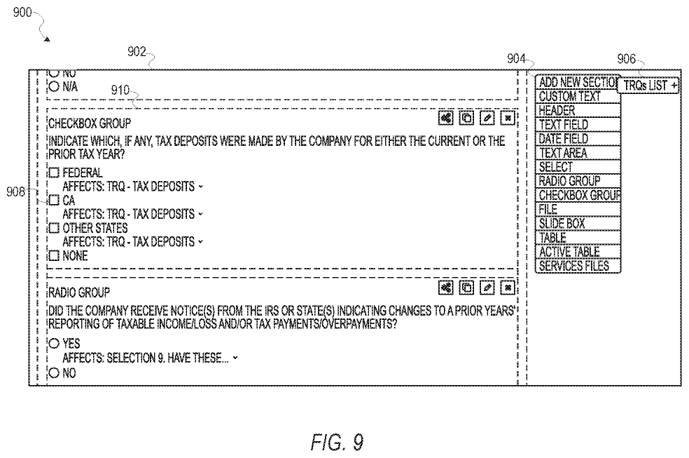

FIG. 9 depicts an interface diagram 900 illustrating a workflow generation interface 902, according to some embodiments.

In some example embodiments, the distributed data collection system 124 receives inputs to define one or more interactive forms that comprise a workflow through the workflow generation interface 902. As seen in the interface diagram 900, the workflow generation interface 902 may include a presentation of a set of configuration options 904. A user may provide an input selecting one or more options from among the set of configuration options 904 to configure an interactive form of a workflow. For example, as seen in the interface diagram 900, the set of configuration options 904 may comprise a list of interface elements, such as a header, a text field, a date field, a text area, a radio group, etc.

As seen in the interface diagram 900, the interactive forms of a workflow may include a questionnaire that comprises a series of questions (e.g., question 910). In such embodiments, a user may define a set of response options, such as the response options 908. For example, the user may provide an input that identifies a number of response options for a question, as well as a type of response options (e.g., yes or no, or multiple choice).

In further embodiments, the user may provide inputs to associate one or more documents in a document library to each option among the set of response options 908. For example, the workflow generation interface 902 may comprise a presentation of a document list 906. A user may identify documents from the document list 906, and provide inputs that select and associate one or more documents from the document list 906 to one or more response options from among the set of response options 908.

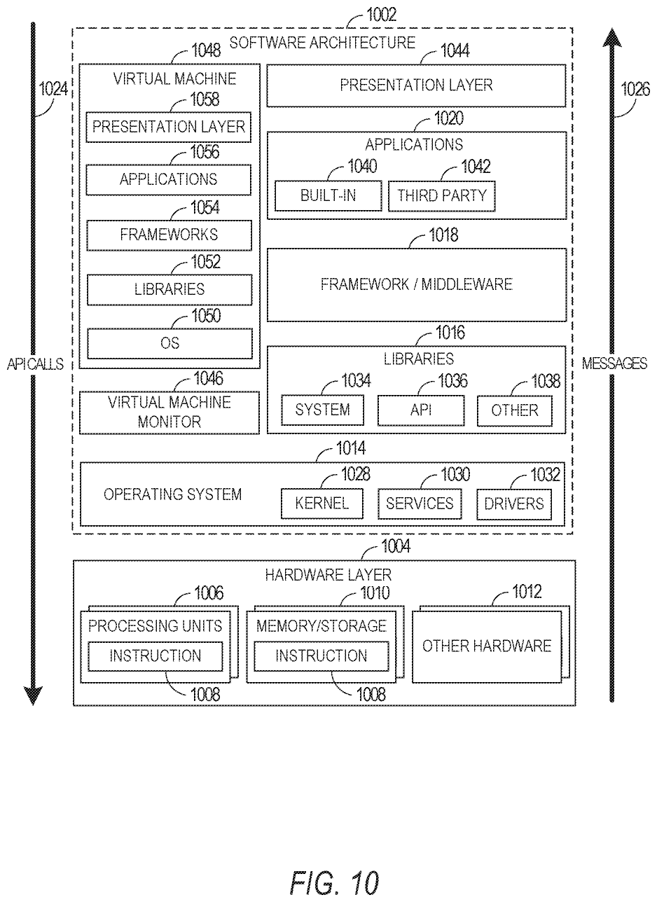

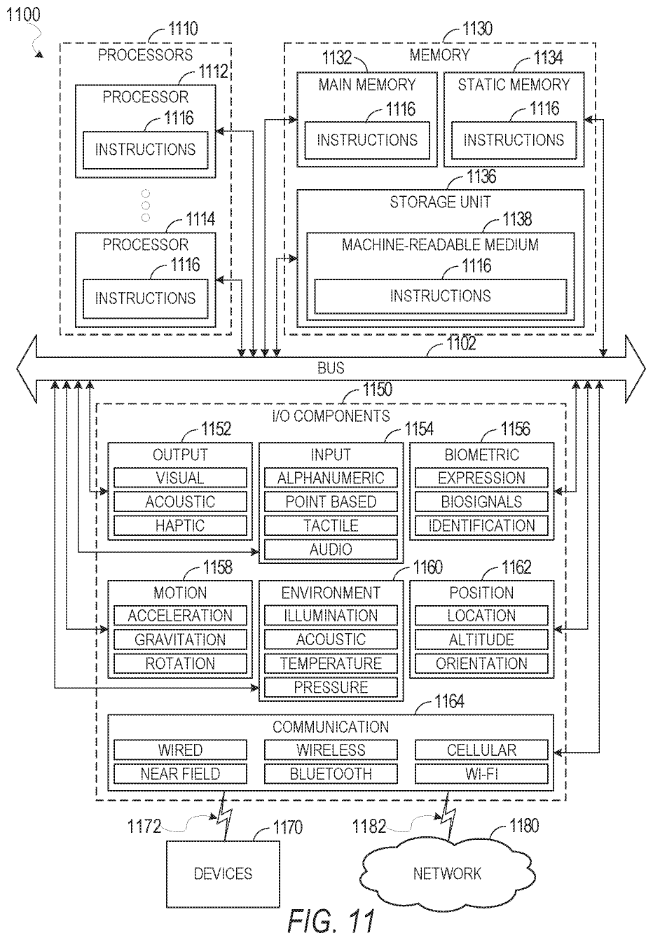

FIG. 10 is a block diagram illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and I/O components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002, including implementation of the methods, modules, and so forth of FIGS. 1-9. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine (e.g., the machine 1100 of FIG. 11). The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 300 of FIG. 3. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RNID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an application-specific integrated circuit (ASIC). A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can he achieved through signal transmission (e.g., over appropriate circuits and buses) between or among two or more of the hardware modules, in embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 1100, but deployed across a number of machines 1100. In some example embodiments, the processors 610 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 1130, 1132, 1134, and/or the memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the teams “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 1180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term. Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more.” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is provisionally claimed is:

1. A method comprising:
receiving a workflow definition from a first client device, the workflow definition comprising a set of interactive forms that includes at least a first interactive form;
initiating a communication session between the first client device and a second client device;
causing display of the first interactive form at the first client device and at the second client device in response to the initiation of the communication session;
receiving a response to the first interactive form from the second client device;
identifying at least a first document from a document library based on the response to the first interactive form; and
distributing the first document to the second client device.

2. The method of claim 1, wherein the receiving the workflow definition from the first client device comprises:
associating a workflow identifier with the workflow definition; and
wherein the initiating the communication session between the first client device and the second client device comprises:
causing display of a list of workflow identifiers at the first client device, the list of workflow identifiers including the workflow identifier associated with the workflow definition;
receiving a selection of the workflow identifier from among the list of workflow identifiers from the first client device; and
causing display of the first interactive form of the workflow definition at the first client device and the second client device responsive to the receiving the selection of the workflow identifier.

3. The method of claim 1, wherein the causing display of the first interactive form of the workflow definition at the first client device and the second client device comprises:
causing display of a shared interface at the first client device and the second client device in response to the initiating the communication session between the first client device and the second client device, the shared interface comprising a presentation of the first interactive form of the workflow definition; and
wherein the receiving the response to the first interactive form from the second client device includes:
causing display of the response to the first interactive form within the shared interface at the first client device and the second client device responsive to the receiving the response from the second client device.

4. The method of claim 1, wherein the first interactive form comprises a set of response options that includes at least a first response option, and the receiving the workflow definition from the first client device comprises:
receiving an input that associates the first document with the first response option from among the set of response options; and
wherein the receiving the response to the first interactive form from the second client device comprises:
receiving a selection of the first response option from among the set of response options from the second client device.

5. The method of claim 1, wherein the distributing the first document to the second client device comprises:
determining a due date of the first document responsive to the identifying the first document based on the response to the first interactive form; and
setting a calendar reminder at the first client device and the second client device based on the due date of the first document.

6. The method of claim 1, wherein the method further comprises:
receiving a submission from the second client device, the submission based on the first document;
storing the submission at a memory location associated with the second client device; and
presenting a notification at the first client device responsive to the receiving the submission from the second client device, the notification including an identification of the second client device and the first document.

7. The method of claim 6, wherein the notification is a first notification, and the method comprises:
receiving a review of the submission from the first client device, the review comprising a review message; and
presenting a second notification at the second client device in response to the receiving the review from the first client device, the second notification comprising a display of the review message.

8. The method of claim 6, wherein the method further comprises:
causing display of a status interface at the first client device, the status interface providing a visualization of a status of a workflow defined by the workflow definition, the visualization comprising:
a presentation of a graphical icon at a position within the status interface, the graphical icon based on the submission from the second client device, and wherein the position of the graphical icon within the status interface corresponds with the second client device.

9. The method of claim 6, wherein the storing the submission at the memory location associated with the second client device comprises:
generating a hash based on the submission; and
recording the hash of the submission on a blockchain.

10. A system comprising:
a memory storing instructions;
a persistent data storage device; and
one or more hardware processors communicatively coupled to the memory and configured by the instructions to perform operations comprising:
receiving a workflow definition from a first client device, the workflow definition comprising a set of interactive forms that includes at least a first interactive form;
initiating a communication session between the first client device and a second client device;
causing display of the first interactive form of the workflow definition at the first client device and at the second client device in response to the initiation of the communication session;
receiving a response to the first interactive form from the second client device;
identifying at least a first document from a document library based on the response to the first interactive form; and
distributing the first document to the second client device.

11. The system of claim 10, wherein the receiving the workflow definition from the first client device comprises:
associating a workflow identifier with the workflow definition; and
wherein the initiating the communication session between the first client device and the second client device comprises:
causing display of a list of workflow identifiers at the first client device, the list of workflow identifiers including the workflow identifier associated with the workflow definition;
receiving a selection of the workflow identifier from among the list of workflow identifiers from the first client device; and
causing display of the first interactive form of the workflow definition at the first client device and the second client device responsive to the receiving the selection of the workflow identifier.

12. The system of claim 10, wherein the causing display of the first interactive form of the workflow definition at the first client device and the second client device comprises:
causing display of a shared interface at the first client device and the second client device in response to the initiating the communication session between the first client device and the second client device, the shared interface comprising a presentation of the first interactive form of the workflow definition; and
wherein the receiving the response to the first interactive form from the second client device comprises:
causing display of the response to the first interactive form within the shared interface at the first client device and the second client device responsive to the receiving the response from the second client device.

13. The system of claim 10, wherein the first interactive form comprises a set of response options that includes at least a first response option, and the receiving the workflow definition from the first client device comprises:
receiving an input that associates the first document with the first response option from among the set of response options; and
wherein the receiving the response to the first interactive form from the second client device comprises:
receiving a selection of the first response option from among the set of response options from the second client device.

14. The system of claim 10, wherein the distributing the first document to the second client device comprises:
determining a due date of the first document responsive to the identifying the first document based on the response to the first interactive form; and
setting a calendar reminder at the first client device and the second client device based on the due date of the first document.

15. The system of claim 10, wherein the instructions cause the system to perform operations further comprising:
receiving a submission from the second client device, the submission based on the first document;
storing the submission at a memory location associated with the second client device; and
presenting a notification at the first client device responsive to the receiving the submission from the second client device, the notification including an identification of the second client device and the first document.

16. The system of claim 15, wherein the notification is a first notification, and the instructions cause the system to perform operations further comprising:
receiving a review of the submission from the first client device, the review comprising a review message; and
presenting a second notification at the second client device in response to the receiving the review from the first client device, the second notification comprising a display of the review message.

17. The system of claim 15, wherein the instructions cause the system to perform operations further comprising:
causing display of a status interface at the first client device, the status interface providing a visualization of a status of a workflow defined by the workflow definition, the visualization comprising:
a presentation of a graphical icon at a position within the status interface, the graphical icon based on the submission from the second client device, and wherein the position of the graphical icon within the status interface corresponds with the second client device.

18. The system of claim 15, wherein the storing the submission at the memory location associated with the second client device comprises:
generating a hash based on the submission; and
recording the hash of the submission on a blockchain.

19. A computer-readable storage medium comprising instructions that, when executed by one or more processors, cause a mobile device to perform operations that include:
receiving a workflow definition from a first client device, the workflow definition comprising a set of interactive forms that includes at least a first interactive form;
initialing a communication session between the first client device and a second client device;
causing display of the first interactive form of the workflow definition at the first client device and at the second client device in response to the initiation of the communication session;
receiving a response to the first interactive form from the second client device;
identifying at least a first document from a document library based on the response to the first interactive form; and
distributing the first document to the second client device.

20. The computer-readable storage medium of claim 19, wherein the receiving the workflow definition from the first client device comprises:
associating a workflow identifier with the workflow definition; and
wherein the initiating the communication session between the first client device and the second client device comprises:
causing display of a list of workflow identifiers at the first client device, the list of workflow identifiers including the workflow identifier associated with the workflow definition;
receiving a selection of the workflow identifier from among the list of workflow identifiers from the first client device; and
causing display of the first interactive form of the workflow definition at the first client device and the second client device responsive to the receiving the selection of the workflow identifier.
